(19) United States
(12) Patent Application Publication
(10) Pub. No.: US 2007/0064268 A1
(43) Pub. Date: Mar. 22, 2007

(54) Image forming apparatus, control method therefor, program, and image forming system

(75) Inventor: Yasuhiro Hino, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 11/514,188

(22) Filed: Sep. 1, 2006

(30) Foreign Application Priority Data
Sep. 5, 2005 (JP) 2005-256860

(51) Int. Cl. G06F 3/12

(52) U.S. Cl. 358/1.15

(57) ABSTRACT

A locale where a given image forming apparatus is installed is determined. On the basis of the determination result, a priority image forming unit is decided from a plurality of image forming units provided in the image forming apparatus. Identification information containing an identifier of the decided image forming unit is transmitted in response to an information request transmitted from an information processing apparatus.

### BACKGROUND OF THE INVENTION

1. Field of the Invention

The present invention relates to an image forming apparatus which is connected to a network and is communicable with an information processing apparatus on the network, a control method therefor, a program, and an image forming system including the image forming apparatus and information processing apparatus.

2. Description of the Related Art

Conventionally, image forming apparatuses (e.g., printers and multifunction peripherals) that are connected to a network and receive an operation from a computer through the network are used. Some of the image forming apparatuses can extend PDLs (Page Description Languages) processible in the apparatus later to support a plurality of PDLs.

When a device serving as a peripheral device is connected to an information processing apparatus such as a host computer, the device can transmit device information containing the model name and maker name to the information processing apparatus. Upon receiving the device information, the information processing apparatus can refer to the device ID in the device information and selectively install a device driver specified by the device ID. This technique is called “plug and play”.

Printer driver installation processing by general plug and play will be described with reference to FIG. 1.

Referring to FIG. 1, a general personal computer (PC) or workstation is used as a host computer, i.e., an example of an information processing apparatus 100. Assume that a plurality of driver sets 101 to 103 are stored in the information processing apparatus 100 in advance as drivers packaged in the operating system (OS) of the apparatus.

Each of the driver sets 101 to 103 includes an INF file 104 that describes unique information to be referred to in installing the driver, various kinds of execution modules 105, and resources 106. A device ID is described in the INF file 104. The device ID is formed from the value of an MFG tag as a maker name and the value of an MDL tag as a product name in device information received upon plug and play.

The device ID is used as an identifier to make an image forming apparatus (printer) accurately correspond to a device driver at the time of installation. When the information processing apparatus 100 is connected to an image forming apparatus 107 through a communication medium 108 such as USB, the image forming apparatus 107 detects the connection. After detecting the connection, the image forming apparatus 107 transmits, to the information processing apparatus 100 through the communication medium 108, device information 109 defined by IEEE1284 and containing unique information of the image forming apparatus 107. The device information 109 defined by IEEE1284 contains pieces of information shown in FIG. 2.

Upon receiving the device information 109, the OS in the information processing apparatus 100 reads out the CLS tag from the device information 109, detects that the target of plug and play is the image forming apparatus 107, and starts installing a corresponding driver set. The OS generates a device ID including the MFG tag and MDL tag in the device information 109 and searches for a driver set with the INF file 104 containing the device ID from the driver sets 101 to 103.

When the driver set corresponding to the device information 109 is found, the various kinds of execution modules 105 and resources 106 in the driver set are installed in the OS. The installed driver set is connected to a port of the communication medium 108 that has received the device information 109. If no corresponding driver set is present in the information processing apparatus 100, the processing is ended without installation.

The device information shown in FIG. 2 will be described.

The format of the device information shown in FIG. 2 includes a “tag” column representing tag names and a “value” column representing possible tag values. A CLS tag stores “PRINTER” as its value. The CLS tag stores the apparatus type as its value. In this case, this tag indicates that the connected peripheral device is an image forming apparatus.

An MFG tag stores “ABC” as its value. The MFG tag indicates the maker name. That is, it indicates that ABC is the maker. An MDL tag stores “LBP-XXX PDL1” as its value. The MDL tag indicates the model name and PDL type. In this case, this tag indicates that the model of the peripheral device is LBP-XXX, and the PDL type is PDL1.

A CMD tag stores “PDL1, IEEE1284” as its value. The value of the CMD tag includes the command and PDL name to be transmitted/received through the communication medium. In this case, this tag indicates that the peripheral device would transmit/receive a command group PDL1 as the PDL type by using IEEE1284 as the communication medium type.

In the information processing apparatus 100 that has received the device information 109 shown in FIG. 2, the OS generates a device ID “ABC LBP-XXX PDL1” for the values of the MFG and MDL tags. A driver set is searched by using the device ID as a key.

Plug-and-play techniques using a local interface such as USB or a network interface such as LAN are also proposed. Examples are SOAP (Simple Object Access Protocol)-based Web service protocols called WS-Discovery and WS-MetadataExchange.

The information processing apparatus can detect the presence of a device on the network and acquire device information from the detected device by using these techniques. Hence, the driver of the device on the network can be installed by the same plug and play as in the local interface.

A technique of causing a user to set a PDL to be used in an image forming apparatus and downloading a printer driver from a server apparatus into an information processing apparatus has already been proposed as well (Japanese Patent Laid-Open No. 2002-229751).

However, the above-described conventional techniques install a plurality of drivers even on an information processing apparatus when an image forming apparatus has a plurality of PDLs. In most cases, although a general user uses a PDL with little concern for its type in printing, the information processing apparatus installs a plurality of drivers. This may confuse the user.

Although an image forming apparatus generally employs a PDL unique to its shipment destination region (country), the conventional techniques do not consider any country (location) to install the image forming apparatus. For this reason, the user suffers trouble to set a PDL in correspondence with the location.

### SUMMARY OF THE INVENTION

The present invention has been made to solve the above problems, and has as its object to provide an image forming apparatus capable of causing an information processing apparatus to install a driver desired by a user by selecting an appropriate PDL and presenting device information to the information processing apparatus, and increasing the convenience for the user, a control method of the apparatus, and a program.

According to the present invention, the foregoing object is attained by providing an image forming apparatus which is connected to a network and can communicate with an information processing apparatus on the network, comprising:

a plurality of image forming means;

determination means for determining a locale where a given image forming apparatus is installed;

decision means for deciding priority image forming means from the plurality of image forming means on the basis of a determination result obtained by the determination means; and

transmission means for transmitting, in response to an information request transmitted from the information processing apparatus, identification information containing an identifier of the image forming means decided by the decision means.

In a preferred embodiment, the apparatus further comprises:

designation means for designating the priority image forming means separately for each locale; and

storage means for storing locale information representing the priority image forming means separately for each locale, which is designated by the designation means.

In a preferred embodiment, the apparatus further comprises:

reception means for receiving a search request from the information processing apparatus; and

response means for interpreting a type designated by the search request and making a response only when the given image forming apparatus includes the type.

In a preferred embodiment, the determination means determines, on the basis of a time difference between a time measured by a clock built into the given image forming apparatus and a time of the locale where the given image forming apparatus is installed, the locale where the given image forming apparatus is installed.

In a preferred embodiment, the determination means determines, on the basis of a power supply voltage value detected by the given image forming apparatus, the locale where the given image forming apparatus is installed.

In a preferred embodiment, the determination means determines, on the basis of a network setting value set in the given image forming apparatus, the locale where the given image forming apparatus is installed.

In a preferred embodiment, the determination means determines, on the basis of a display language setting value set in the given image forming apparatus, the locale where the given image forming apparatus is installed.

In a preferred embodiment, the transmission means transmits identification information containing locale information representing the locale determined by the determination means, in addition to the identifier of the image forming means decided by the decision means.

According to the present invention, the foregoing object is attained by providing an image forming system formed by connecting an image forming apparatus to an information processing apparatus through a network, wherein

the image forming apparatus comprises a plurality of image forming means,

determination means for determining a locale where a given image forming apparatus is installed,

decision means for deciding priority image forming means from the plurality of image forming means on the basis of a determination result obtained by the determination means, and

transmission means for transmitting, in response to an information request transmitted from the information processing apparatus, identification information containing an identifier of the image forming means decided by the decision means; and

the information processing apparatus comprises reception means for receiving the identification information from the image forming apparatus, and

installation means for installing, on the basis of the identification information received by the reception means, a device driver to use the image forming apparatus.

According to the preset invention, the foregoing object is attained by providing a control method of an image forming apparatus which is connected to a network and can communicate with an information processing apparatus on the network, comprising:

a determination step of determining a locale where a given image forming apparatus is installed;

a decision step of deciding, on the basis of a determination result obtained in the determination step, priority image forming means from a plurality of image forming means provided in the image forming apparatus; and

a transmission step of transmitting, in response to an information request transmitted from the information processing apparatus, identification information containing an identifier of the image forming means decided in the decision step.

According to the present invention, the foregoing object is attained by providing a program stored in a computer-readable medium, which causes a computer to execute control of an image forming apparatus which is connected to a network and can communicate with an information processing apparatus on the network, causing the computer to execute:

a determination step of determining a locale where a given image forming apparatus is installed;

a decision step of deciding, on the basis of a determination result obtained in the determination step, priority image forming means from a plurality of image forming means provided in the image forming apparatus; and

a transmission step of transmitting, in response to an information request transmitted from the information processing apparatus, identification information containing an identifier of the image forming means decided in the decision step.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a view for explaining printer driver installation processing using plug and play;

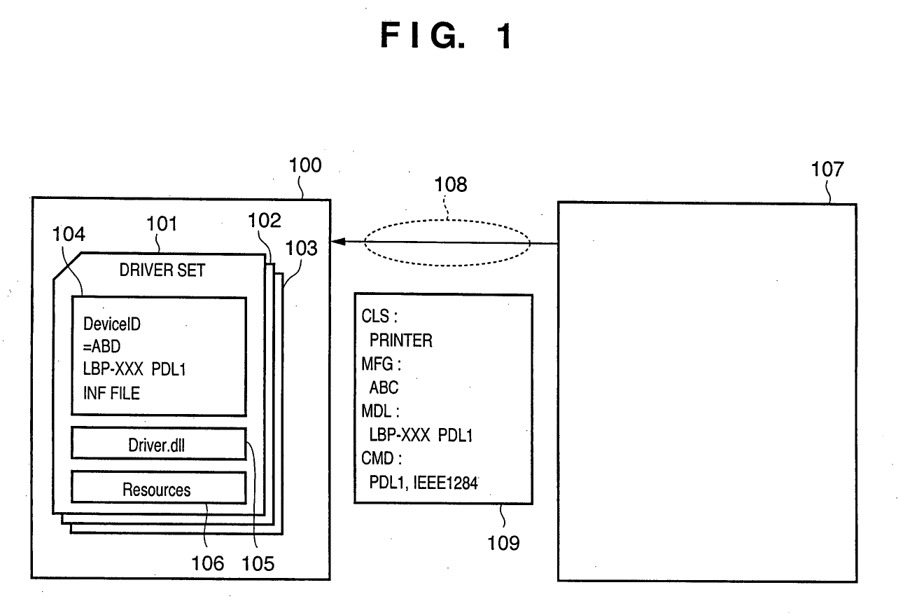

FIG. 2 is a view for explaining device information defined by IEEE1284;

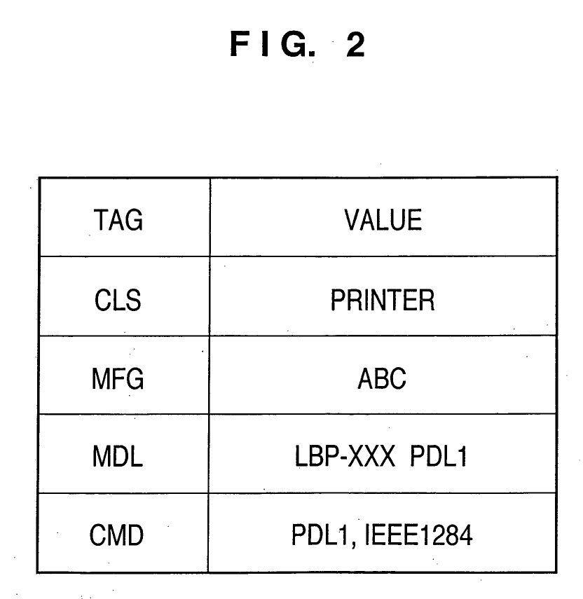

FIG. 3 is a view showing a configuration example of an image forming system according to the first embodiment of the present invention;

FIG. 4 is a block diagram showing the hardware configuration of a device according to the first embodiment of the present invention;

FIG. 5 is a block diagram showing the detailed arrangement of a host computer according to the first embodiment of the present invention;

FIG. 6 is a sequence chart of printer driver installation according to the first embodiment of the present invention;

FIG. 7 is a view showing an example of a device search request according to the first embodiment of the present invention;

FIG. 8 is a flowchart showing determination processing according to the first embodiment of the present invention;

FIG. 9 is a view showing an example of device information according to the first embodiment of the present invention;

FIG. 10 is a view showing an example of service information according to the first embodiment of the present invention;

FIG. 11 is a view showing an example of service name information according to the first embodiment of the present invention;

FIG. 12 is a flowchart showing generation processing according to the first embodiment of the present invention;

FIG. 13 is a view showing an example of setting information according to the first embodiment of the present invention;

FIG. 14A is a view showing an example of a setting window according to the first embodiment of the present invention;

FIG. 14B is a view showing an example of a setting window according to the first embodiment of the present invention;

FIG. 14C is a view showing an example of a setting window according to the first embodiment of the present invention;

FIG. 15 is a flowchart showing details of locale determination processing according to the first embodiment of the present invention;

FIG. 16 is a flowchart showing details of locale determination processing according to the second embodiment of the present invention;

FIG. 17 is a flowchart showing details of locale determination processing according to the third embodiment of the present invention;

FIG. 18 is a flowchart showing details of locale determination processing according to the fourth embodiment of the present invention; and

FIG. 19 is a flowchart showing generation processing according to the fifth embodiment of the present invention.

### DESCRIPTION OF THE EMBODIMENTS

Preferred embodiments of the present invention will be described in detail in accordance with the accompanying drawings.

<First Embodiment>

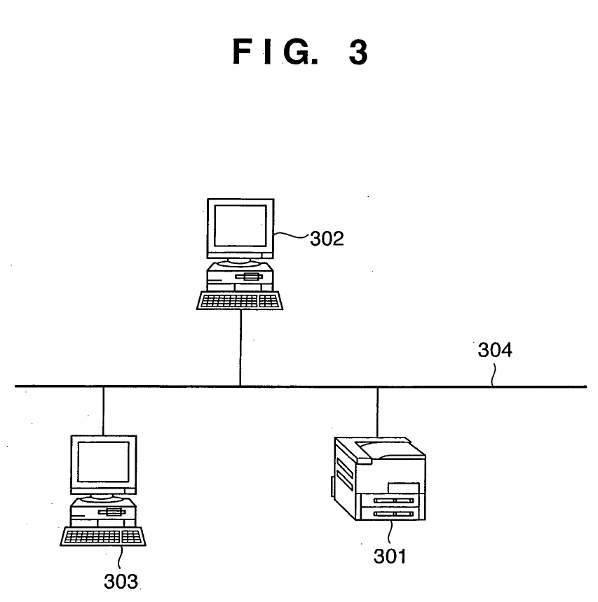

FIG. 3 is a view showing a configuration example of an image forming system according to the first embodiment of the present invention.

In the image forming system shown in FIG. 3, a device 301 and host computers 302 and 303 are connected to each other through a network 304.

The network 304 is a so-called communication network that is typically implemented by one of the Internet, LAN, WAN, telephone line, dedicated digital line, ATM, frame relay line, communication satellite channel, cable TV line, and data broadcast channel or a combination thereof. The network 304 only needs to transmit/receive data.

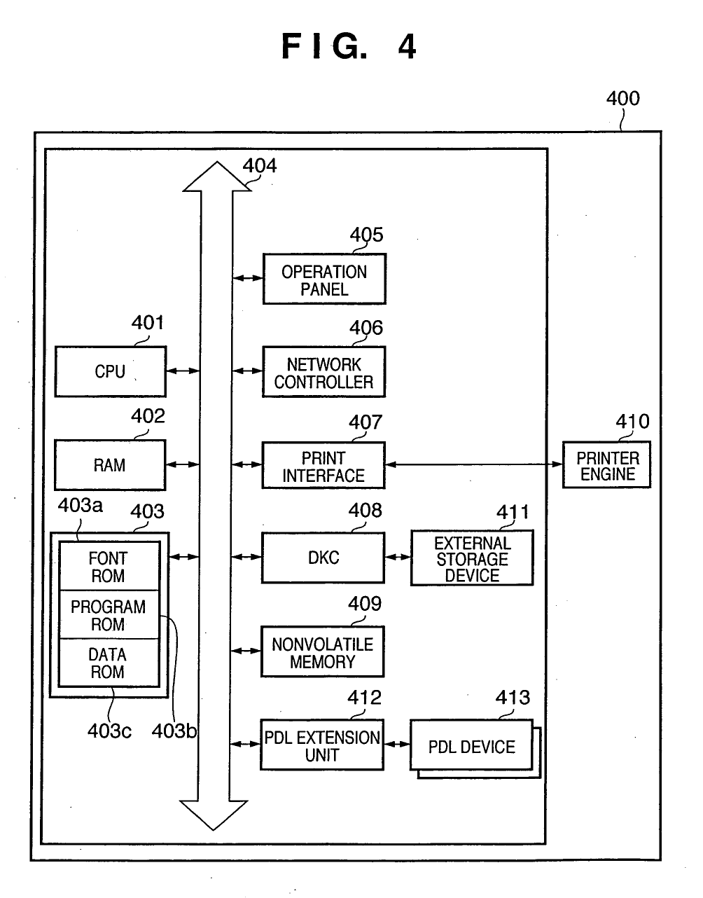

The hardware configuration of the device 301 will be described next with reference to FIG. 4.

FIG. 4 is a block diagram showing the hardware configuration of the device according to the first embodiment of the present invention.

As the device, a laser beam printer 400 serving as an image forming apparatus will be exemplified here.

In the printer 400 shown in FIG. 4, a CPU 401 collectively controls access to various kinds of devices connected to a system bus 404 on the basis of a control program stored in a program ROM 403b of a ROM 403. The CPU 401 outputs an image signal as output information to a print unit (printer engine) 410 connected through a print interface 407.

The control program stored in the program ROM 403b includes programs to implement various kinds of flowcharts to be described later. The CPU 401 executes various kinds of processing operations shown in the flowcharts by executing the programs. The control program stored in the program ROM 403b also includes a program to convert an input PDL (Page Description Language) to bitmap data printable by the printer engine 410. When the program is executed by the CPU 401, the printer 400 functions as an image forming means.

The program ROM 403b of the ROM 403 stores control programs executable by the CPU 401. A font ROM 403a of the ROM 403 stores font data (including outline font data) to be used to generate output information. A data ROM 403c of the ROM 403 stores data to be used on the host computer (e.g., host computer 302).

The CPU 401 can execute communication processing with the host computer on the network 304 through a network controller 406. A RAM 402 mainly functions as the main memory or work area of the CPU 401. The RAM 402 is designed to extend the memory capacity by using an optional RAM connected to an extension port (not shown). The RAM 402 is used as an output information rasterization area or environment data storage area.

Access to an external storage device 411 such as a hard disk (HD) or IC card is controlled by a disk controller (DKC) 408. The external storage device 411 is used as a job storage area to store font data, an emulation program, and form data, temporarily spool a print job, and control the spooled job from the outside.

An operation panel 405 includes, e.g., a touch panel, and various kinds of keys and buttons so that the user can input various types of information from software keys displayed on the touch panel. A nonvolatile memory 409 stores various types of information such as printer mode setting information input from the operation panel 405.

Various kinds of extension units such as a finisher to execute stapling and sorting and a double-sided printing unit to implement double-sided printing can be attached to the printer 400 as options. The operations of the units are controlled from the CPU 401.

A PDL extension unit 412 connects at least one PDL device (PDL board) 413 which can be controlled from the CPU 401. The PDL device 413 serves as an image forming unit (image forming means) having a function of interpreting print data (PDL) received from the host computer and converting the data into bitmap data printable by the printer engine 410. At least one PDL device 413 is normally connected. More PDL devices 413 can be added later. Device information defined by IEEE1284 used in plug and play is held by the PDL device 413.

In the first embodiment to be described below, the device is assumed to have PDL1 as the standard PDL device unless otherwise specified. A PDL of another type such as PDL2 can be added and extended as an optional PDL device.

Extension of the PDL device may be done by physically adding an extension board with a dedicated PDL device to the printer 400. If the PDL device is implemented by a program, a corresponding program may be added to the program ROM 403b. A PDL device may be added by storing programs corresponding to a plurality of kinds of PDL devices in the program ROM 403b in advance and validating a necessary PDL device by using a license key input by user operation.

Examples of the PDL are LIPS, PostScript, and PCL.

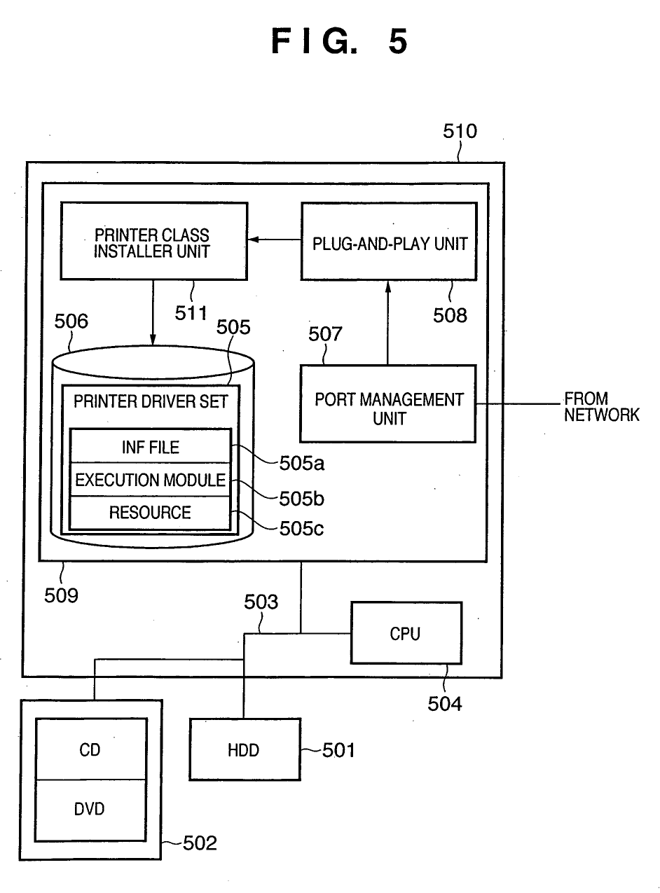

The detailed arrangement of the host computer 302 or 303 will be described next with reference to FIG. 5.

FIG. 5 is a block diagram showing the detailed arrangement of the host computer according to the first embodiment of the present invention.

In an information processing apparatus 510 corresponding to each of the host computers 302 and 303, an HDD 501 is a hard disk drive with a large capacity. The HDD 501 can store in advance a program module to be loaded to a RAM 509 and a driver set 505 including an INF file. An external storage device 502 including a CD/DVD-ROM/RAM drive also has the same function.

A program module group implemented on the RAM 509 includes a port management unit 507, plug-and-play unit 508, printer class installer unit 511, and at least one printer driver set 505 managed on a driver library 506. The RAM 509 reads out the program modules from the HDD 501 and executes them as needed.

A CPU 504 collectively controls the printer class installer unit 511, plug-and-play unit 508, port management unit 507, and driver library 506, reads out each processing from the HDD 501 to the RAM 509, and executes the processing.

A BUS 503 connects the various kinds of constituent elements (CPU 504, RAM 509, HDD 501, and external storage device 502) of the information processing apparatus 510 to each other.

The port management unit 507 controls the interface on the side of the information processing apparatus 510 connected to the network 304 for communication with the device 400. In automatically installing a printer driver, the port management unit 507 receives device information defined by IEEE1284 and transfers it to the plug-and-play unit 508.

The plug-and-play unit 508 is a module to execute information control with a device for plug and play. The plug-and-play unit 508 generates a device ID from the values of MFG and MDL tags in the device information received from the port management unit 507. The plug-and-play unit 508 then transfers the generated device ID to the printer class installer unit 511.

The printer class installer unit 511 is a module to install a printer driver. On the basis of the device ID received from the plug-and-play unit 508, the printer class installer unit 511 searches for a printer driver set corresponding to the device ID from at least one printer driver set 505. When the printer driver set is found, the printer driver is installed and assigned to a necessary port.

The printer driver set 505 includes an execution module group 505b such as a DLL, a resource 505c, and an INF file 505a that describes their features for installation in correspondence with a printer driver.

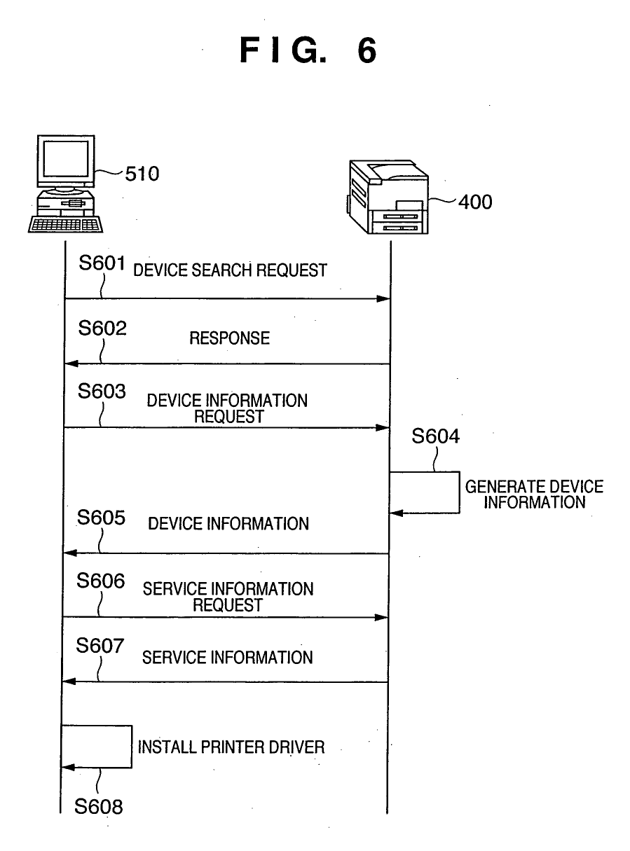

The sequence of printer driver installation implemented between the information processing apparatus (host computer) 510 and the device (printer) 400 will be described next with reference to FIG. 6.

FIG. 6 is a sequence chart of printer driver installation according to the first embodiment of the present invention.

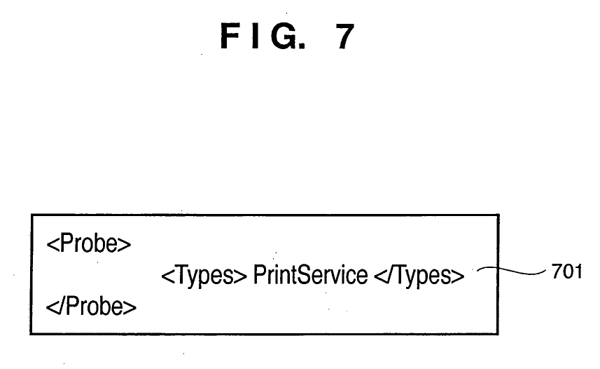

In step S601, the information processing apparatus 510 transmits a device search request to the network. The device search request is information described by, e.g., an XML format shown in FIG. 7 and is transmitted using multicast. A <Types> element 701 in FIG. 7 describes the type of device as the search target. For example, the type of function such as a print service or scan service or the type of PDL device such as a print service with PDL1 can be described.

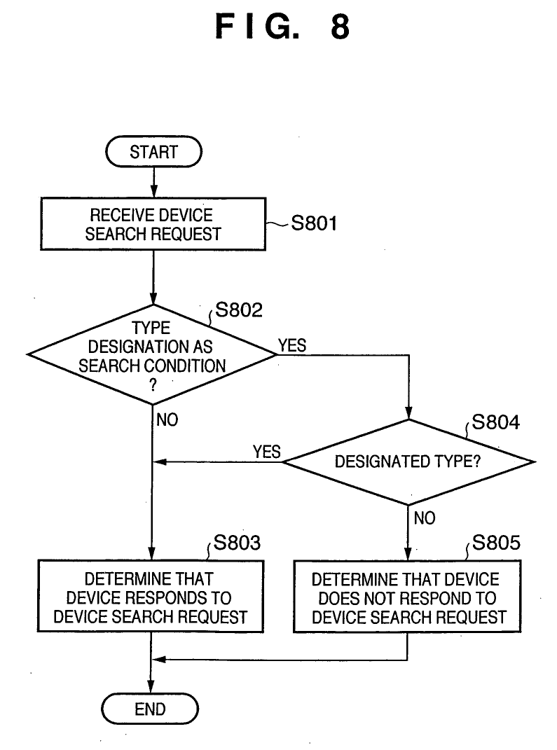

All devices existing in the multicast reachable range receive the device search request. Each device determines in accordance with the flowchart in FIG. 8 to be described later whether the device responds to this request.

For example, if the device 400 determines that the device 400 responds, the device 400 transmits a response to the device search request to the information processing apparatus 510 in step S602. In step S603, the information processing apparatus 510 transmits a device information request to the found device (the device that has transmitted the response). If the device 400 should notify that it has participated in the network, the device 400 transmits the network participation notification to the information processing apparatus 510 instead of the processing in steps S601 and S602. In step S603, the information processing apparatus 510 transmits a device information request to the device on the basis of the network participation notification from the device 400.

Upon receiving the device information request, the device 400 generates device information by a method (to be described later) in step S604. In step S605, the generated device information is transmitted to the information processing apparatus 510.

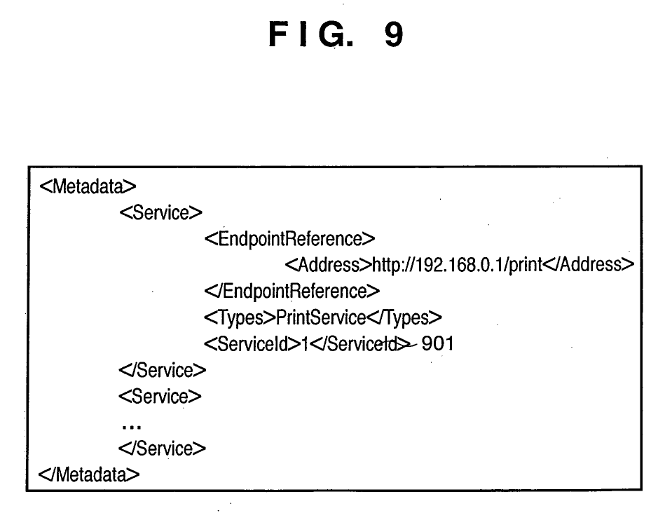

The device information (identification information) is described in, e.g., an XML format shown in FIG. 9 and contains a list of services provided by the device. The value of a <ServiceID> element 901 in FIG. 9 indicates a unique ID (service ID), i.e., an identifier to identify each service and is used to specify a necessary service later.

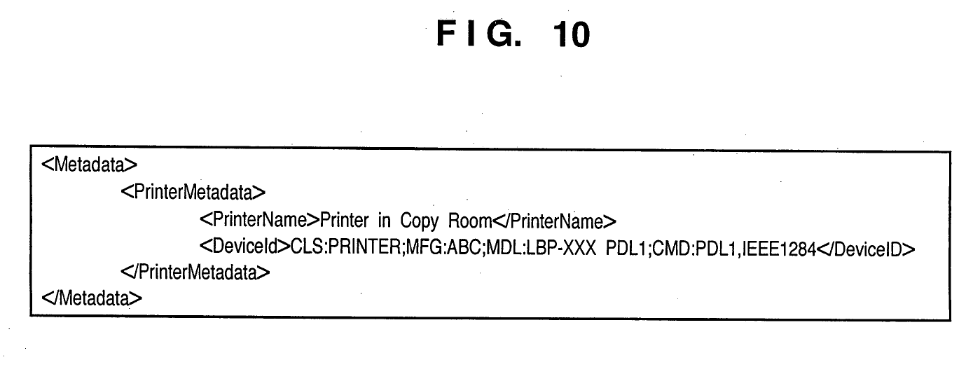

In step S606, the information processing apparatus 510 designates a necessary service ID from the received device information and transmits a service information request. Upon receiving the service information request, the device 400 acquires the value of device information from a PDL device corresponding to the designated service ID and transmits service information containing the value to the information processing apparatus 510 in step S607. The service information is described in, e.g., an XML format shown in FIG. 10.

In step S608, the information processing apparatus 510 refers to the service information received from the device 400 and installs a corresponding printer driver. If the device 400 transmits device information containing a plurality of service lists to the information processing apparatus 510 in step S605, steps S606 to S608 are repeated. Printer drivers equal in number to the listed services are installed.

Determination processing of determining whether the device 400 that has received the device search request responds to this request in the sequence shown in FIG. 6 will be described next with reference to FIG. 8.

FIG. 8 is a flowchart showing determination processing according to the first embodiment of the present invention.

In step S801, the device 400 receives a device search request. In step S802, the presence/absence of type designation by a <Types> tag in the device search request is determined as the search condition. If no type is designated (NO in step S802), the received device search request indicates exhaustive device search. The process advances to step S803 to determine that the device 400 responds to the device search request.

If a type is designated (YES in step S802), the process advances to step S804 to determine whether the designated type is included in the type of the device itself. If the designated type is included in the type of the device itself (YES in step S804), the process advances to step S803. If the designated type is not included in the type of the device itself (NO in step S804), the process advances to step S805 to determine that the device 400 does not respond to the device search request.

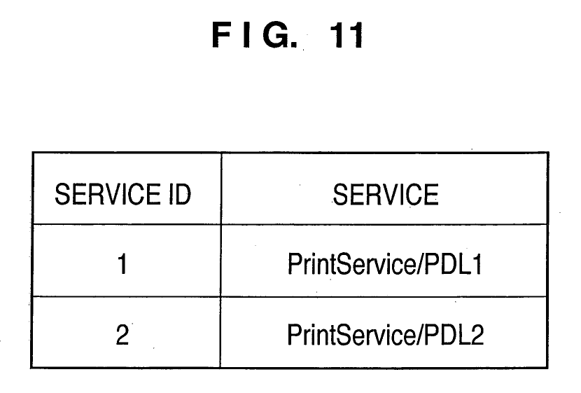

The type of the device itself used for determination in step S804 indicates the PDL device attached to the device 400 and service name information of the service of the PDL device, as shown in FIG. 11. The device 400 detects a PDL device attached to itself, generates service name information on the basis of the detection result, and holds the generated information in the RAM 402, as needed. In this case, as shown in FIG. 11, the device manages each PDL device as one PrintService and assigns a service ID to each service in the service list information.

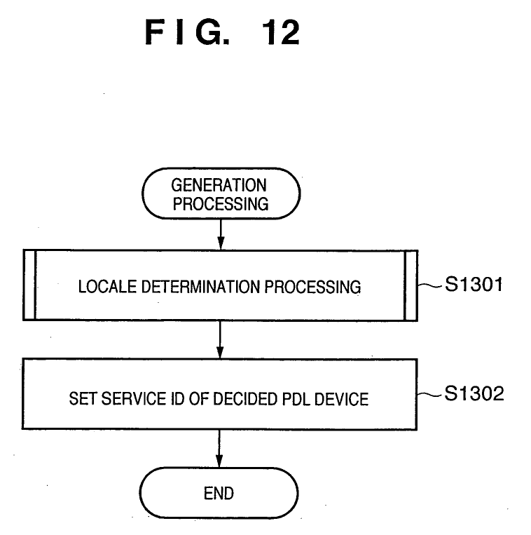

Generation processing of causing the device to generate a service list contained in device information in step S604 of the sequence shown in FIG. 6 will be described next with reference to FIG. 12.

FIG. 12 is a flowchart showing generation processing according to the first embodiment of the present invention.

In step S1301, the device 400 executes locale determination processing of determining a region (locale) where the device 400 is installed. On the basis of the locale information (regional information) obtained by the determination result, the device 400, decides a PDL device responded as a service.

In step S1302, the service ID corresponding to the decided PDL device is acquired from the service name information (FIG. 11) and set as the value of <ServiceID> in device information.

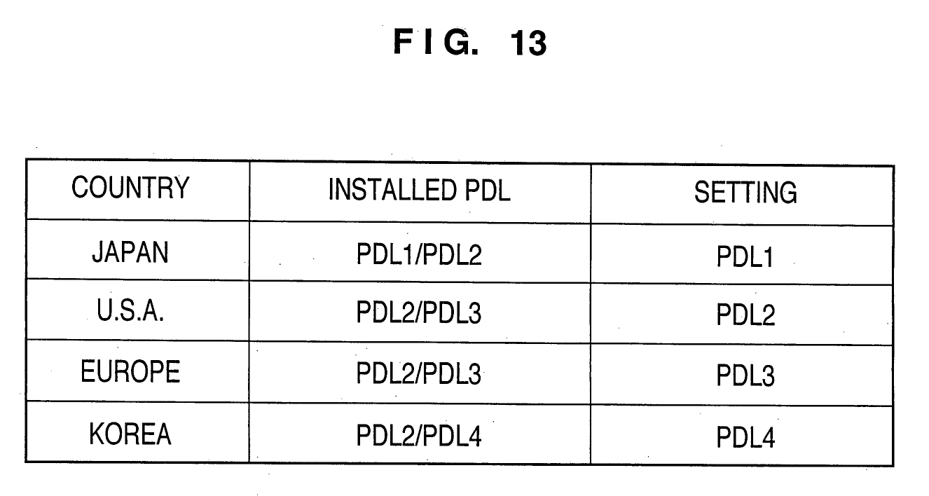

In the first embodiment, the device 400 sets, in advance as specific setting information (locale information) shown in FIG. 13 in shipment from the factory, locale-specific PDL devices each of which is responded as a service. The nonvolatile memory 409, for example, stores the setting information.

In the example shown in FIG. 13, the device contains PDL1 and PDL2 for Japan while the device contains PDL2 and PDL3 for U.S.A. Similarly, the device contains PDL2 and PDL3 for Europe while the device contains PDL2 and PDL4 for Korea. In this case, the device 400 sets, as setting values, PDL1, PDL2, PDL3, and PDL4 for Japan, U.S.A., Europe, and Korea, respectively in shipment from the factory.

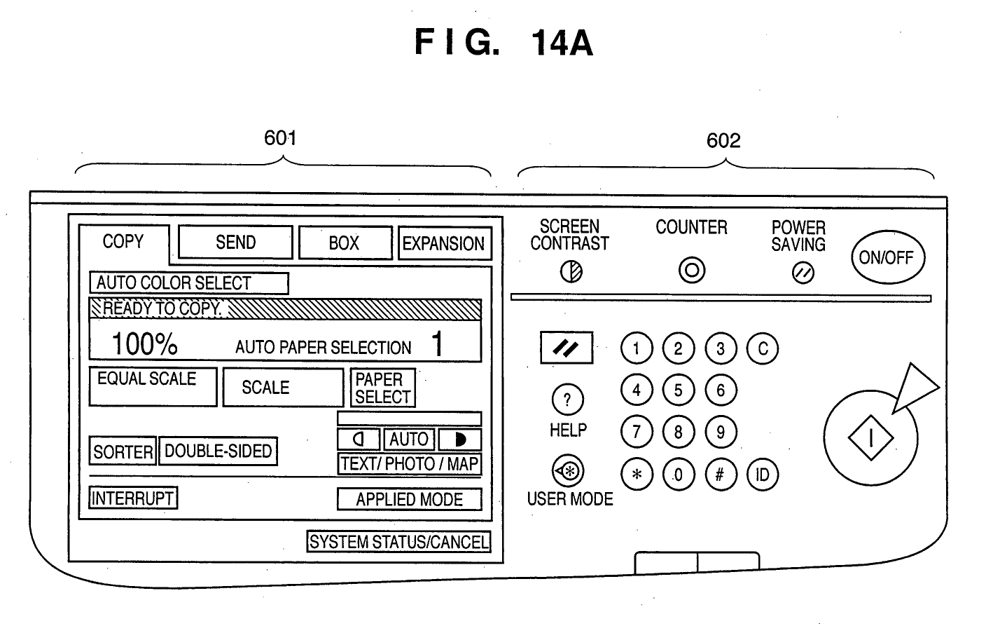

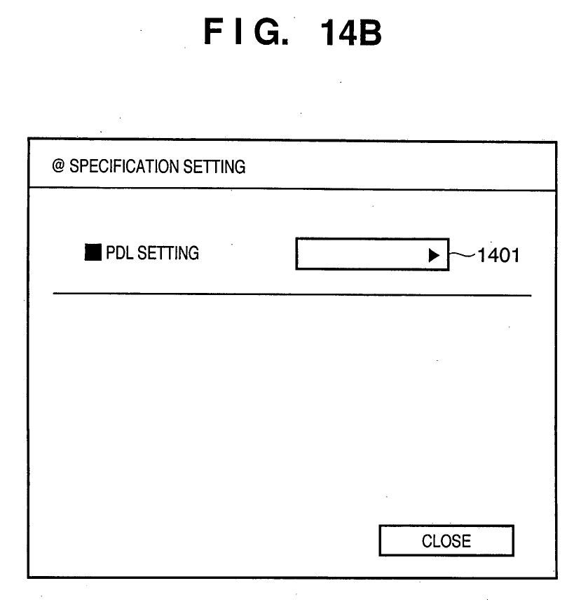

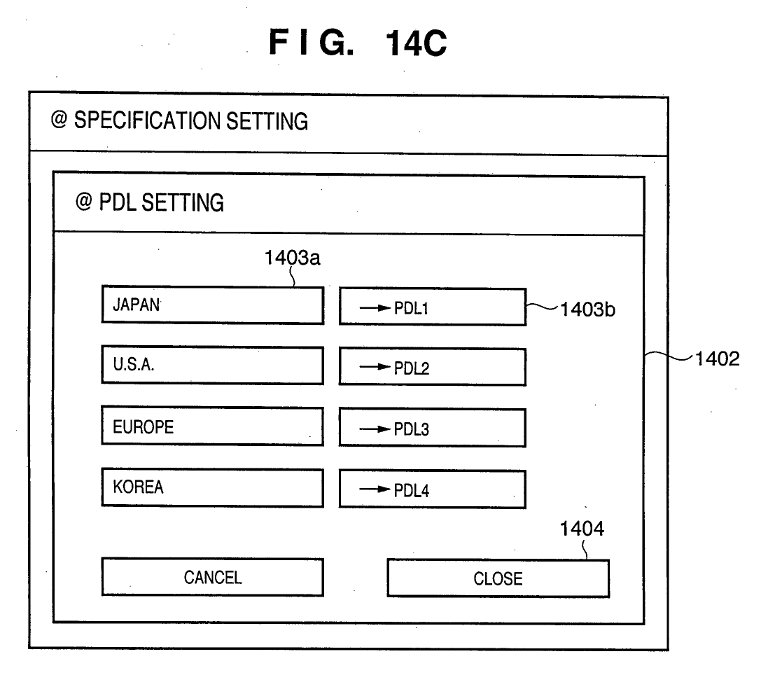

A setting window to set the setting information will be described here with reference to FIGS. 14A to 14C.

FIGS. 14A to 14C are views showing examples of setting windows according to the first embodiment of the present invention.

The operation panel 405 of the device includes a key input unit 602 and touch panel unit 601.

The key input unit 602 allows the user to set routine operations. Various kinds of switches and keys are arranged on the key input unit 602, and allow the user to execute various kinds of operations and to input setting values.

The touch panel unit 601 includes an LCD (Liquid Crystal Display) and a touch panel display formed from a transparent electrode which adheres to the surface of the LCD. In this case, processing of, e.g., displaying another operation window by detecting that the user has touched, with his/her finger, a portion of the transparent electrode corresponding to a key displayed on the LCD is programmed in advance. The window shown in FIG. 14A is an initial window in a standby mode and can display various kinds of operation windows in accordance with setting operations.

The initial window includes various kinds of tab windows (e.g., a “Copy” tab, “Send” tab, and “Box” tab). The “Copy” tab is a tab key for shifting the current window to a copy operation window. The “Send” tab is a tab key for shifting the current window to a sending instruction operation window for FAX or E-mail. The “Box” tab is a tab key for shifting the current window to an operation window to input/output a job to/from a box (a storage means for storing a job for each user). The “Expansion” tab is a tab key for shifting the current window to an expansion function setting window for a scanner or printer. Selecting these tabs makes it possible to shift the current mode to the corresponding operation modes.

To set information (locale information), the user selects the “Expansion” tab. With this operation, a specification setting window shown in FIG. 14B is displayed.

When the user operates a “PDL setting” menu 1401 in the specification setting window, a PDL setting window 1402 shown in FIG. 14C is displayed.

The PDL setting window 1402 displays a country corresponding to the device (a country to which the device is shipped). This makes it possible to set a PDL device responded as a service for each country.

For example, the PDL setting window 1402 prepares a designation item 1403b to designate a PDL device corresponding to a “Japan” country item 1403a. In this case, for example, it is possible to selectively designate “PDL1” and “PDL2” as the types of the designation item.

The PDL setting window 1402 can display the designation item 1403b while sequentially switching, in accordance with an operation, a plurality of types of PDL devices installed in the device in advance. When the PDL setting window 1402 displays a PDL device desired by the user, he/she can operate a close button 1404 to set a PDL device (a PDL device to be preferentially used) corresponding to a locale indicated by a country item. After this operation, the nonvolatile memory 409 stores, as setting information (locale information), the locale and the PDL device corresponding to that locale.

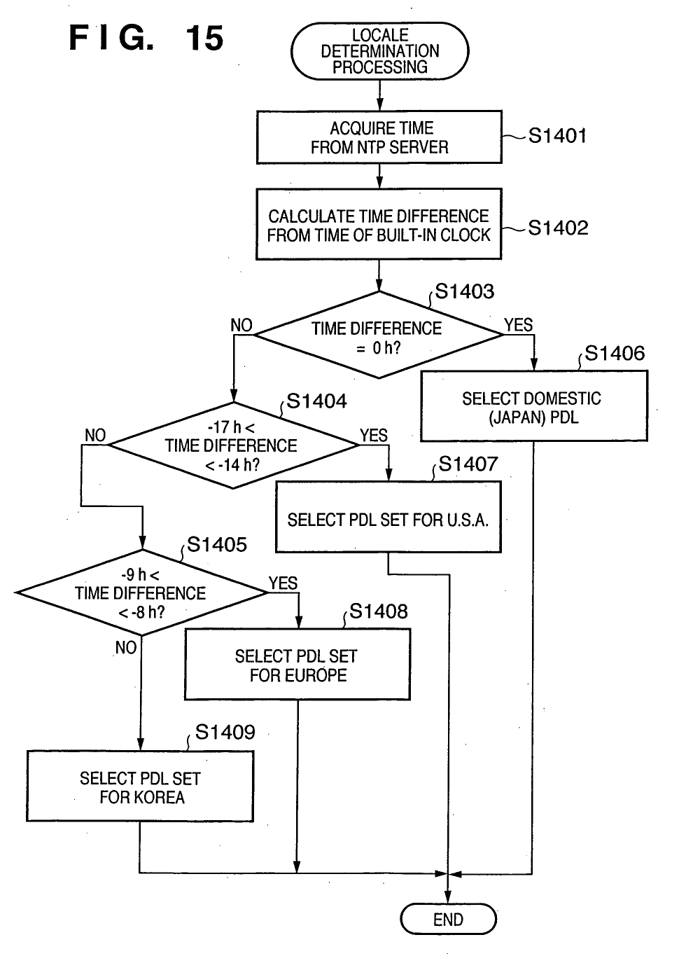

Details of locale determination processing shown in FIG. 12 will be described next with reference to FIG. 15.

FIG. 15 is a flowchart showing details of locale determination processing according to the first embodiment of the present invention.

In the first embodiment, by utilizing the “time difference” between a clock (timer) built into the device 400 and the standard time of a country where the device 400 is installed, the device 400 determines a locale, where the device 400 is installed. The built in timer may be formed in the device 400 as a physical timer or implemented as a soft timer by the CPU 401.

In step S1401, from an NTP (Network Time Protocol) server (a time synchronization server), the device 400 acquires the standard time of a region where the device 400 is installed.

At this time, the NTP server in the region where the device is installed may be a public NTP server or a constituent component on the network connected to the device. It is possible to acquire the address of the NTP server by using the service provision mechanism described with reference to FIG. 6.

In step S1402, the device 400 calculates the difference (time difference) between a time measured by the clock built into the device and the time acquired from the NTP server.

At this time, the clock built into the device may be the world standard time (Greenwich Time in England). In the first embodiment, however, the clock built into the device employs Japanese Standard Time (JST).

In step S1403, the device 400 determines whether the calculated time difference is +/−0 h (hour). If the time difference is +/−0 h (YES in step S1403), the device 400 recognizes that the time acquired from the NTP server is Japan time. That is, the device 400 recognizes that the locale where the device 400 is installed is Japan. In this case, in step S1406, the device 400 refers to setting information and selects a domestic (Japan) PDL device. In the example of the setting information shown in FIG. 13, the device 400 selects PDL1.

If the calculated time difference is not +/−0 h (NO in step S1403), the device 400 determines in step S1404 whether −17 h <time difference <−14 h holds. If −17 h <time difference <−14 h holds (YES in step S1404), the device 400 recognizes that the time acquired from the NTP server is U.S.A. time. That is, the device 400 recognizes that the locale where the device 400 is installed is U.S.A. In this case, in step S1407, the device 400 refers to setting information and selects a PDL device set for U.S.A. In the example of the setting information shown in FIG. 13, the device 400 selects PDL2.

If −17 h <time difference <−14 h does not hold (NO in step S1404), the device 400 determines in step S1405 whether −9 h <time difference <−8 h holds. If −9 h <time difference <−8 h holds (YES in step S1405), the device 400 recognizes that the time acquired from the NTP server is Europe time. That is, the device 400 recognizes that the locale where the device 400 is installed is Europe. In this case, in step S1408, the device 400 refers to setting information and selects a PDL device set for Europe. In the example of the setting information shown in Fig. 13, the device 400 selects PDL3.

If −9 h <time difference <−8 h does not hold (NO in step S1405), the device 400 determines that the locale where the device 400 is installed is Korea. In this case, in step S1409, the device 400 refers to setting information and selects a PDL device set for Korea. In the example of the setting information-shown in FIG. 13, the device 400 selects PDL4.

Locale determination by time difference shown in FIG. 15 is merely an example and is performed in accordance with a required locale type.

As described above, according to the first embodiment, an image forming apparatus manages locale-specific setting information representing a priority PDL for each device. On the basis of the setting information, the image forming apparatus automatically selects a suitable PDL device to be preferentially used in a locale where the image forming apparatus is installed, and notifies an information processing apparatus of device information representing the selection result. Hence, the information processing apparatus can install a printer driver desired by a user, thus increasing the convenience for the user.

<Second Embodiment>

In the first embodiment, the device determines the locale by utilizing the time difference. However, the present invention is not limited to this. For example, the voltage value of a power supply used by a device changes depending on the locale. The second embodiment will be described with reference to a case wherein a device determines the locale by utilizing the power supply voltage value.

A CPU-401, for example, can acquire the voltage value of a power supply in a locale where a device is installed and powered on.

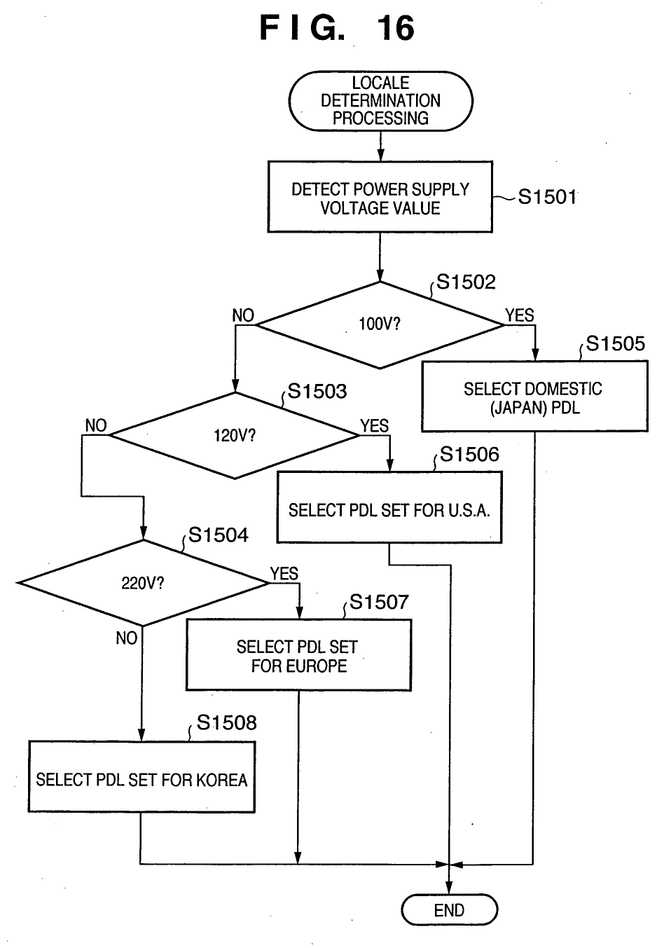

FIG. 16 is a flowchart showing details of locale determination processing according to the second embodiment of the present invention.

In step S1501, a device 400 detects the voltage value of its power supply. The device 400 determines in step S1502 whether the power supply voltage value is 100 V. If the power supply voltage value is 100 V (YES in step S1502), the device 400 determines that the locale where the device 400 is installed is Japan. In step S1505, the device 400 refers to setting information and selects a PDL device set for Japan. In the example of the setting information shown in FIG. 13, the device 400 selects PDL1.

If the power supply voltage value is not 100 V (NO in step S1502), the device 400 determines in step S1503 whether the power supply voltage value is 120 V. If the power supply voltage value is 120 V (YES in step S1503), the device 400 determines that the locale where the device 400 is installed is U.S.A. In step S1506, the device 400 refers to setting information and selects a PDL device set for U.S.A. In the example of the setting information shown in FIG. 13, the device 400 selects PDL2.

If the power supply voltage is not 120 V (NO in step S1503), the device 400 determines in step S1504 whether the power supply voltage value is 220 V. If the power supply voltage value is 220 V (YES in step S1504), the device 400 determines that the locale where the device 400 is installed is Europe. In step S1507, the device 400 refers to setting information and selects a PDL device set for Europe. In the example of the setting information shown in FIG. 13, the device 400 selects PDL3.

If the power supply voltage value is not 220 V (NO in step S1504), the device 400 determines that the locale where the device 400 is installed is Korea. In step S1508, the device 400 refers to setting information and selects a PDL device set for Korea. In the example of the setting information shown in FIG. 13, the device 400 selects PDL4.

Locale determination by power supply voltage value shown in FIG. 16 is merely an example and is performed in accordance with a required locale type.

As described above, according to the second embodiment, a device can determine the locale by utilizing the power supply voltage value, in addition to the effect described in the first embodiment.

<Third Embodiment>

In the first embodiment, the device determines the locale by utilizing the time difference. However, the present invention is not limited to this. For example, the setting value of a network connected to a device changes depending on the locale. The third embodiment will be described with reference to a case wherein a device determines the locale by utilizing the network setting value (e.g., DNS Suffix).

A user (a network administrator in most cases) sets the network setting value through an operation panel 405 in order to connect an installed device 400 to the network. The network setting value may adopt an IP address or DNS (Domain Name Service) setting information which is a general setting item necessary for network connection. When the user invokes a setting window to set these items, a nonvolatile memory 409, for example, stores the network setting values. The nonvolatile memory 409 may store setting information (various kinds of values set through the operation panel 405) containing these network setting items.

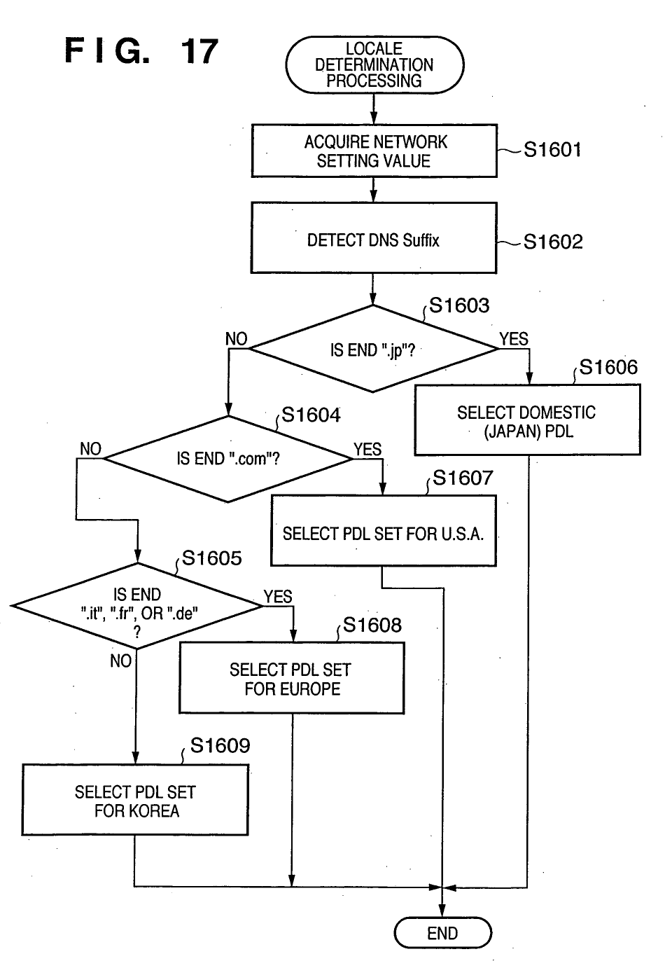

FIG. 17 is a flowchart showing details of locale determination processing according to the third embodiment of the present invention.

In step S1601, the device 400 refers to the nonvolatile memory 409 and acquires network setting values associated with the device 400. In step S1602, the device 400 detects a DNS suffix from the acquired network setting values. In this case, DNS Suffix serves as a very common network setting item and represents, as a character string, a domain name to be supplemented when the user designates a partial host name that is not an FQDN (Fully Qualified Domain Name).

In step S1603, the device 400 determines whether DNS Suffix has “.jp” at its end. If the end is “.jp” (YES in step S1603), the device 400 determines that the locale where the device 400 is installed is Japan. In step S1606, the device 400 refers to setting information and selects a PDL device set for Japan. In the example of the setting information shown in FIG. 13, the device 400 selects PDL1.

If the end is not “.jp” (NO in step S1603), the device 400 determines in step S1604 whether DNS Suffix has “.com” at its end. If the end is “.com” (YES in step S1604), the device 400 determines that the locale where the device 400 is installed is U.S.A. In step S1607, the device 400 refers to setting information and selects a PDL device set for U.S.A. In the example of the setting information shown in FIG. 13, the device 400 selects PDL2.

If the end is not “.com” (NO in step S1604), the device 400 determines in step S1605 whether DNS Suffix has one of “.it”, “.fr”, and “.de” at its end. If the end coincides with one of them (YES in step S1605), the device 400 determines that the locale where the device 400 is installed is Europe. In step S1608, the device 400 refers to setting information and selects a PDL device set for Europe. In the example of the setting information shown in FIG. 13, the device 400 selects PDL3.

If the end is none of “.it”, “.fr”, and “.de” (NO in step S1605), the device 400 determines that the locale where the device 400 is installed is Korea. In step S1609, the device 400 refers to setting information and selects a PDL device set for Korea. In the example of the setting information shown in FIG. 13, the device 400 selects PDL4.

Locale determination by DNS Suffix shown in FIG. 17 is merely an example and is performed in accordance with a required locale type.

As described above, according to the third embodiment, a device can determine the locale by utilizing the network setting value, in addition to the effect described in the first embodiment.

<Fourth Embodiment>

In the first embodiment, the device determines the locale by utilizing the time difference. However, the present invention is not limited to this. For example, the setting value of a language displayed on an operation panel 405 of a device changes depending on the locale. The fourth embodiment will be described with reference to a case wherein a device determines the locale by utilizing the display language setting value.

The display language setting value is an installation value set in advance in a device 400 in shipment from the factory. The operation panel displays a language (e.g., Japanese or English) of various kinds of operation windows in accordance with the setting value. However, it is also possible to invoke a setting window to set the setting item at an arbitrary timing so as to update the display language setting value. A nonvolatile memory 409, for example, stores the display language setting value. The nonvolatile memory 409 may store setting information (various kinds of values set through the operation panel 405) containing the display language setting value.

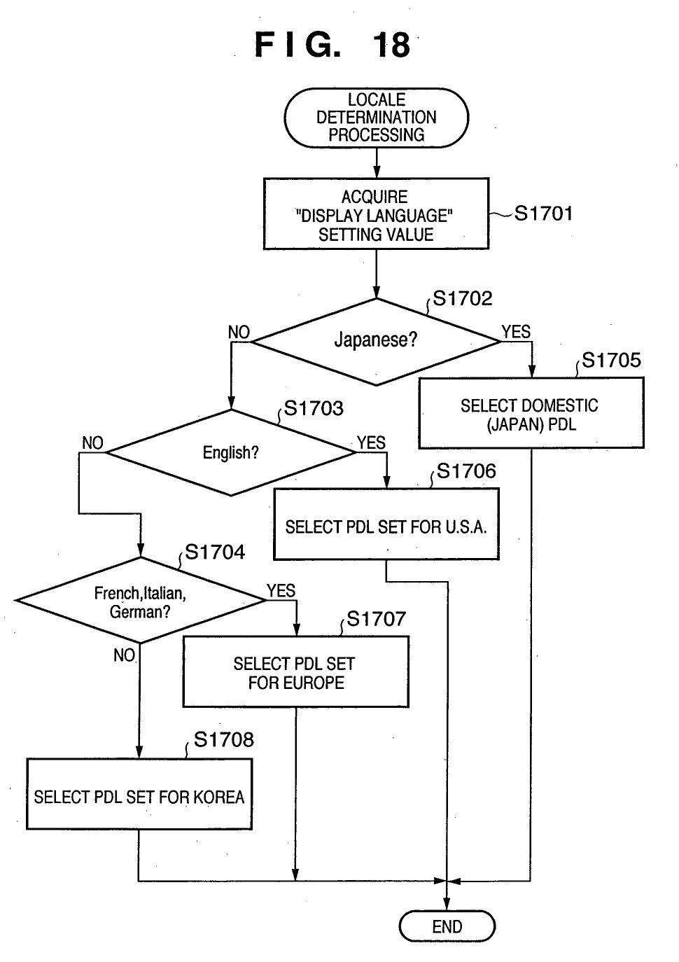

FIG. 18 is a flowchart showing details of locale determination processing according to the fourth embodiment of the present invention.

In step S1701, the device 400 acquires a display language setting value associated with the device 400. The device 400 determines in step S1702 whether the display language setting value is “Japanese”. If the display language setting value is “Japanese” (YES in step S1702), the device 400 determines that the locale where the device 400 is installed is Japan. In step S1705, the device 400 refers to setting information and selects a PDL device set for Japan. In the example of the setting information shown in FIG. 13, the device 400 selects PDL1.

If the display language setting value is not “Japanese” (NO in step S1702), the device 400 determines in step S1703 whether the display language setting value is “English”. If the display language setting value is “English” (YES in step S1703), the device 400 determines that the locale where the device 400 is installed is U.S.A. In step S1706, the device 400 refers to setting information and selects a PDL device set for U.S.A. In the example of the setting information shown in FIG. 13, the device 400 selects PDL2.

If the display language setting value is not “English” (NO in step S1703), the device 400 determines in step S1704 whether the display language setting value is one of “French”, “Italian”, and “German”. If the display language setting value is one of them (YES in step S1704), the device 400 determines that the locale where the device 400 is installed is Europe. In step S1707, the device 400 refers to setting information and selects a PDL device set for Europe. In the example of the setting information shown in FIG. 13, the device 400 selects PDL3.

If the display language setting value is none of “French”, “Italian”, and “German” (NO in step S1704), the device 400 determines that the locale where the device 400 is installed is Korea. In step S1708, the device 400 refers to setting information and selects a PDL device set for Korea. In the example of the setting information shown in FIG. 13, the device 400 selects PDL4.

Locale determination by display language setting value shown in FIG. 18 is merely an example and is performed in accordance with a required locale type.

As described above, according to the fourth embodiment, a device can determine the locale by utilizing the display language setting value, in addition to the effect described in the first embodiment.

<Fifth Embodiment>

In the first to fourth embodiments, the device 400 uses locale information determined by itself. However, the present invention is not limited to this. For example, a device 400 notifies an information processing apparatus 510 of locale information determined by the device 400. This makes it possible to switch, in accordance with the locale information, a display language of a driver UI (User Interface) when the information processing apparatus 510 installs the corresponding driver.

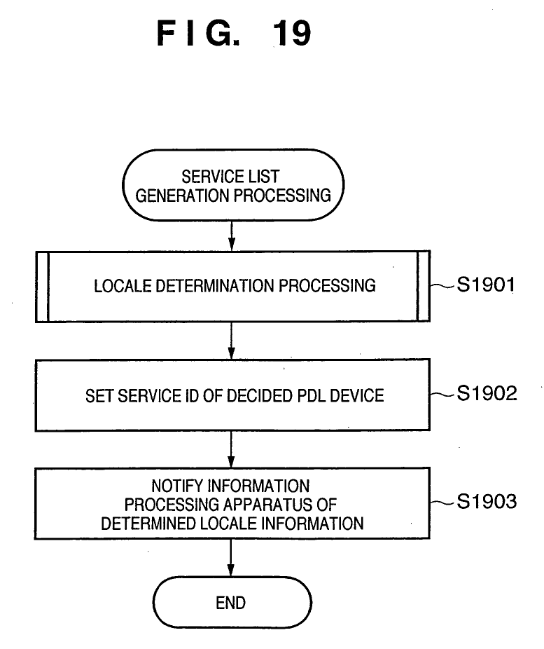

The device 400 can notify the information processing apparatus 510 of the location information by forming it on a service list of device information. Service list generation processing in this case will be described with reference to FIG. 19.

FIG. 19 is a flowchart showing generation processing according to the fifth embodiment of the present invention.

First, in step S1901, the device 400 executes locale determination processing. The device 400 practices this locale determination processing by using one of the above-described first to fourth embodiments. On the basis of the locale information (regional information) obtained by the determination result, the device 400 decides a PDL device responded as a service.

Second, in step S1902, the service ID corresponding to the decided PDL device is acquired from the service name information (FIG. 11) and set as the value of <ServiceID> in device information.

Last, in step S1903, the device 400 notifies the information processing apparatus 510 of the decided locale information. Adding the ID indicating the locale into the service list of the device information shown in FIG. 9 makes it possible to easily attain the notification method.

As described above, according to the fifth embodiment, a device can notify an information processing apparatus of information associated with a display language of a UI (User Interface) of a driver to be installed in the information processing apparatus, in addition to the effect described in the first embodiment.

<Sixth Embodiment>

In the first to fifth embodiments, the device determines the locale at a timing when the device receives a device information request from the information processing apparatus 510. However, the present invention is not limited to this. For example, a device may determine the locale upon powering on the device. In the first embodiment, the device decides, on the basis of information set in advance in shipment from the factory, a PDL device responded as a service. However, it is also possible to change the PDL device afterward in a different way through an operation panel 405.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-256860, filed Sep. 5, 2005, which is hereby incorporated by reference herein in its entirety.

What is claimed is:

1. An image forming apparatus which is connected to a network and can communicate with an information processing apparatus on the network, comprising:
a plurality of image forming means;
determination means for determining a locale where a given image forming apparatus is installed;
decision means for deciding priority image forming means from said plurality of image forming means on the basis of a determination result obtained by said determination means; and
transmission means for transmitting, in response to an information request transmitted from the information processing apparatus, identification information containing an identifier of said image forming means decided by said decision means.

2. The apparatus according to claim 1, further comprising:
designation means for designating the priority image forming means separately for each locale; and
storage means for storing locale information representing the priority image forming means separately for each locale, which is designated by said designation means.

3. The apparatus according to claim 1, further comprising:
reception means for receiving a search request from the information processing apparatus; and
response means for interpreting a type designated by the search request and making a response only when the given image forming apparatus includes the type.

4. The apparatus according to claim 1, wherein said determination means determines, on the basis of a time difference between a time measured by a clock built into the given image forming apparatus and a time of the locale where the given image forming apparatus is installed, the locale where the given image forming apparatus is installed.

5. The apparatus according to claim 1, wherein said determination means determines, on the basis of a power supply voltage value detected by the given image forming apparatus, the locale where the given image forming apparatus is installed.

6. The apparatus according to claim 1, wherein said determination means determines, on the basis of a network setting value set in the given image forming apparatus, the locale where the given image forming apparatus is installed.

7. The apparatus according to claim 1, wherein said determination means determines, on the basis of a display language setting value set in the given image forming apparatus, the locale where the given image forming apparatus is installed.

8. The apparatus according to claim 1, wherein said transmission means transmits identification information containing locale information representing the locale determined by said determination means, in addition to the identifier of said image forming means decided by said decision means.

9. An image forming system formed by connecting an image forming apparatus to an information processing apparatus through a network, wherein
the image forming apparatus comprises
a plurality of image forming means,
determination means for determining a locale where a given image forming apparatus is installed,
decision means for deciding priority image forming means from said plurality of image forming means on the basis of a determination result obtained by said determination means, and
transmission means for transmitting, in response to an information request transmitted from the information processing apparatus, identification information containing an identifier of said image forming means decided by said decision means; and
the information processing apparatus comprises
reception means for receiving the identification information from the image forming apparatus, and
installation means for installing, on the basis of the identification information received by said reception means, a device driver to use the image forming apparatus.

10. A control method of an image forming apparatus which is connected to a network and can communicate with an information processing apparatus on the network, comprising:
a determination step of determining a locale where a given image forming apparatus is installed;
a decision step of deciding, on the basis of a determination result obtained in the determination step, priority image forming means from a plurality of image forming means provided in the image forming apparatus; and
a transmission step of transmitting, in response to an information request transmitted from the information processing apparatus, identification information containing an identifier of the image forming means decided in the decision step.

11. A program stored in a computer-readable medium, which causes a computer to execute control of an image forming apparatus which is connected to a network and can communicate with an information processing apparatus on the network, causing the computer to execute:
a determination step of determining a locale where a given image forming apparatus is installed;
a decision step of deciding, on the basis of a determination result obtained in the determination step, priority image forming means from a plurality of image forming means provided in the image forming apparatus; and
a transmission step of transmitting, in response to an information request transmitted from the information processing apparatus, identification information containing an identifier of the image forming means decided in the decision step.
